(19) United States
(12) Patent Application Publication
(10) Pub. No.: US 2023/0259914 A1
(43) Pub. Date: Aug. 17, 2023

(54) DISPLAY PROCESSING APPARATUS, TRANSACTION SUPPORT APPARATUS, AND PROGRAM

(71) Applicant: TOSHIBA TEC KABUSHIKI KAISHA, Tokyo (JP)

(72) Inventors: Tsuyoshi GOTANDA, Ota Tokyo (JP); Naotake HIRAMATSU, Ota Tokyo (JP); Anna TSUBOI, Ota Tokyo (JP); Suzu KIKUTAKE, Fukuoka Fukuoka (JP)

(21) Appl. No.: 18/082,267

(22) Filed: Dec. 15, 2022

(30) Foreign Application Priority Data
Feb. 15, 2022 (JP) 2022-021615

(51) Int. Cl. G06Q 20/20

(52) U.S. Cl. CPC G06Q 20/208; G06Q 20/18

(57) ABSTRACT

A display processing apparatus includes a communication interface configured to connect to a plurality of transaction support apparatuses and a processor. The processor is configured to receive an event signal related to an event at a transaction support apparatus via the communication interface and display an object corresponding to the transaction support apparatus on a display. If a plurality of objects corresponding to transaction support apparatuses are displayed on the display, the plurality of objects are displayed in a format indicating priority ordering of the transaction support apparatuses set based on the events at the transaction support apparatuses.

### CROSS-REFERENCE TO RELATED APPLICATION

This application is based upon and claims the benefit of priority from Japanese Patent Application No. 2022-021615, filed Feb. 15, 2022, the entire contents of which are incorporated herein by reference.

### FIELD

Embodiments described herein relate generally to a display processing apparatus and a transaction support apparatus.

### BACKGROUND

In recent years, in stores such as a supermarket, a self-service POS (Point of Sales) terminal has been attracting attention for reducing personnel expenses, improving infection control against infectious diseases, and other reasons. The self-service POS terminal can be an apparatus adapted to a full self-service mode by which a customer performs all transaction related operations from registration of items to settlement by himself or herself.

In a store that introduces many self-service POS terminals, staff members of the store generally still have to monitor the self-service POS terminals and handle events that may occur at the self-service POS terminals such as a staff call from a customer at a terminal.

### BRIEF DESCRIPTION OF THE DRAWINGS

FIG. 1 depicts a checkout system of a full self-service type according to an embodiment.

FIG. 2 is a block diagram illustrating a self-service POS terminal according to an embodiment.

FIG. 3 is a block diagram illustrating an attendant terminal according to an embodiment.

FIG. 4 is an example of a first image at a self-service POS terminal.

FIG. 5 is an example of a second image at a self-service POS terminal.

FIG. 6 is another example of a second image at a self-service POS terminal.

FIG. 7 is a display example at an attendant terminal.

FIG. 8 is another display example at an attendant terminal.

FIG. 9 is still another display example at an attendant terminal.

FIG. 10 is a flowchart illustrating display processing of a self-service POS terminal.

FIG. 11 is a flowchart illustrating an example of display processing of an attendant terminal.

FIG. 12 is a flowchart illustrating another example of display processing of an attendant terminal.

### DETAILED DESCRIPTION

An object of embodiments is to improve handling efficiency of a transaction support apparatus and the like.

According to one embodiment, a display processing apparatus includes a communication interface configured to connect to a plurality of transaction support apparatuses and a processor. The processor is configured to receive an event signal related to an event at a transaction support apparatus via the communication interface and then display an object corresponding to the transaction support apparatus on a display. If a plurality of objects corresponding to transaction support apparatuses are displayed on the display, the plurality of objects are displayed in a format indicating a priority ordering of the transaction support apparatuses set based on the events at the transaction support apparatuses.

Certain example embodiments are explained below with reference to the drawings. In the drawings, the same components are denoted by the same reference symbols unless otherwise noted.

(Configuration Example)

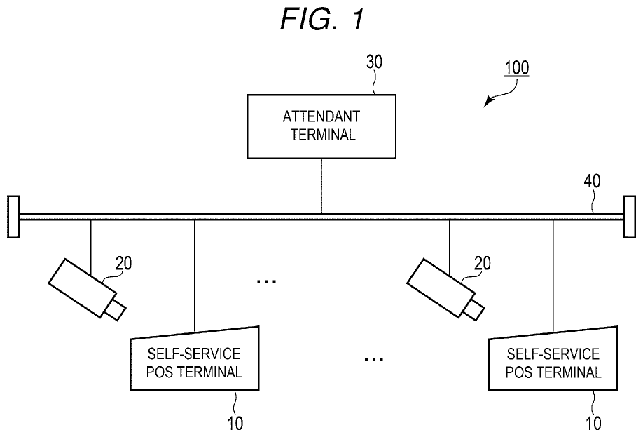

FIG. 1 depicts a checkout system 100 of a full self-service type. The checkout system 100 includes a plurality of self-service POS terminals 10, a plurality of cameras 20, and an attendant terminal 30. The plurality of self-service POS terminals 10, the plurality of cameras 20, and the attendant terminal 30 are communicably connected to one another via a network 40. For example, the network 40 comprises one or more networks such as the Internet, a portable communication network, and a LAN (Local Area Network). The one or more networks may include a wireless network and/or may include a wired network. The checkout system 100 includes at least two pieces of electronic equipment from among the plurality of self-service POS terminals 10, the plurality of cameras 20, and the attendant terminal 30.

The plurality of self-service POS terminals 10 are electronic equipment with which a customer can perform a settlement process relating to a sales transaction from registration of commodities (items) to payment for the registered commodities by himself or herself (e.g., without interaction with a store clerk). The self-service POS terminals 10 are located in a checkout place of a store. The customer puts commodities in a shopping basket or the like while on a selling floor (where commodities are displayed), moves to the checkout place, then operates the self-service POS terminal 10 to perform transaction settlement from registration to payment. The registration of the commodities includes registering the commodities as purchase targets. The self-service POS terminal 10 is an example of a transaction support apparatus for supporting a retail sales transaction of commodities (items). In some examples, the transaction support apparatus may be a dedicated commodity registration apparatus (no payment processing functions) or may be a checkout apparatus (just a payment processing function(s)).

Each of the cameras 20 is electronic equipment that has an imaging function and acquires captured image data based on imaging. For example, a captured image may be video or a still image. The camera 20 may be stand-alone equipment but may be integrated with other equipment such as a tablet terminal or a smartphone. The cameras 20 are positioned in the checkout place of the store.

The cameras 20 images the surroundings of each self-service POS terminals 10. The plurality of cameras 20 include a camera 20 that images a customer who uses one of the self-service POS terminals 10. A single camera 20 may image a customer who uses one self-service POS terminal 10 or a plurality of cameras 20 may image each customer who uses a self-service POS terminal 10. For example, a camera 20 may be positioned to image the face of a customer who uses a self-service POS terminal 10. The plurality of cameras 20 may include a camera 20 that images a hand of a customer who registers a commodity using a self-service POS terminal 10. The plurality of cameras 20 may include a camera 20 that images both the face and the hand of a customer who registers a commodity at self-service POS terminal.

The plurality of cameras 20 may include a camera 20 that images a commodity storage place for commodity returns resulting from a commodity registration cancellation. The commodity storage place for commodity returns may be set separately or in common for each of the self-service POS terminals 10. The plurality of cameras 20 may include a camera 20 that images a commodity storage place for commodity returns after purchase (settlement). The commodity storage place after commodity return after purchase may be set separately or in common for each of the self-service POS terminals 10. The commodity storage place for commodity return after purchase may be the same as or different from the commodity storage place for commodity returns resulting from commodity registration cancellations.

The camera 20 need not be separate from the self-service POS terminal 10. Each self-service POS terminal 10 may integrate or incorporate at least one camera 20.

The attendant terminal 30 is electronic equipment that processes display of information for handling an event at a self-service POS terminal 10. The attendant terminal 30 is a PC (Personal Computer), a tablet terminal, a smartphone, or the like but is not limited to these devices. The attendant terminal 30 may be in the store or outside the store. In one example, the attendant terminal 30 may be on the selling floor where the self-service POS terminal 10 are also set or may be another location in the same store such as a backroom area other than the selling floor. In another example, the attendant terminal 30 may be outside the store at a place such as a call center. An attendant (store clerk or employee) uses the attendant terminal 30. The attendant terminal user is typically a staff member of the store such as a store clerk. In FIG. 1, one attendant terminal 30 is illustrated. However, in other examples, a plurality of attendant terminals 30 may be connected to the network 40. The attendant terminal 30 is an example of a display processing apparatus for processing display of information. The attendant terminal 30 is an example of electronic equipment that is different from the self-service POS terminal 10.

A configuration example of the self-service POS terminal 10 is explained.

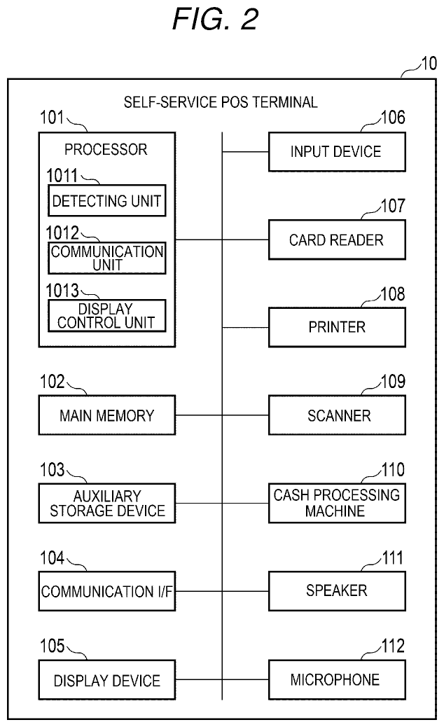

FIG. 2 is a block diagram illustrating the self-service POS terminal 10.

The self-service POS terminal 10 includes a processor 101, a main memory 102, an auxiliary storage device 103, a communication interface 104, a display device 105, an input device 106, a card reader 107, a printer 108, a scanner 109, a cash processing machine 110, a speaker 111, and a microphone 112. The units configuring the self-service POS terminal 10 are connected to one another to be capable of inputting and outputting signals. In FIG. 2, interface is described as “I/F”.

The processor 101 can be a central processor of the self-service POS terminal 10. For example, the processor 101 is a CPU (Central Processing Unit) but is not limited to this. The processor 101 may comprise various circuits. The processor 101 loads, in the main memory 102, a program or programs from the main memory 102 or the auxiliary storage device 103. In this context, the programs are for realizing units (functions) of the processor 101 and causing the processor 101 to execute processing described for the units below. The processor 101 executes various kinds of processing by executing one or more programs loaded in the main memory 102.

The main memory 102 is a main storage part of the self-service POS terminal 10. The main memory 102 includes a nonvolatile memory region and a volatile memory region. The main memory 102 stores an operating system and/or programs in the nonvolatile memory region. The main memory 102 uses the volatile memory region as a work area in which data can be rewritten as appropriate by the processor 101. For example, the main memory 102 may include a ROM (Read Only Memory) serving as the nonvolatile memory region and a RAM (Random Access Memory) as the volatile memory region.

The auxiliary storage device 103 is an auxiliary storage part of the self-service POS terminal 10. The auxiliary storage device 103 may be an EEPROM® (Electric Erasable Programmable Read-Only Memory), a HDD (Hard Disc Drive), an SSD (Solid-State Drive), or the like. The auxiliary storage device 103 stores the programs explained above, data used by the processor 101 in executing the various kinds of processing, and/or data generated by the processing in the processor 101.

The communication interface 104 includes various interfaces for communicably connecting the self-service POS terminal 10 to other electronic equipment via the network 40 according to a predetermined communication protocol.

The display device 105 is capable of displaying various images according to the control of the processor 101. For example, the display device 105 is a liquid crystal display, an EL (Electroluminescence) display, or the like. The display device 105 includes a touch panel. The display device 105 is an example of a display.

The input device 106 is for inputting an instruction based on operation of the customer. The input device 106 may include a button-type input key and/or a touch panel capable of realizing the function of an input key.

The card reader 107 is a device that reads data recorded in a card medium. For example, the card medium is a credit card, an electronic money card, a point card, or the like. The card reader 107 may be or include a device that reads data recorded in a magnetic stripe of a magnetic card. The card reader 107 may be or include a device that reads data recorded in an IC (Integrated Circuit) chip of an IC card.

The printer 108 is for printing an image on a sheet. For example, the printer 108 is a thermal printer, a dot impact printer, or the like.

The scanner 109 is for optically reading code symbols and acquires information from the code symbol (e.g., decodes the code symbol). For example, the code symbol is a barcode symbol or a two-dimensional code symbol. The code symbol may be a code symbol on a commodity (item) that provides identification information for identifying the commodity (item). The code symbol on the commodity may be an image affixed to the commodity. The code symbol may be a member code symbol that provides identification information for identifying the member of a customer loyalty program, points program, or the like. The member code symbol of the member may be an on a member card or an image displayed on a terminal such as a smartphone. The code symbol may be generated for so called “code settlement”. The scanner 109 can be or include a scanner fixed to the self-service POS terminal 10 (e.g., a fixed scanner). The scanner 109 can be or include a handheld or detachable scanner that the customer can hold and manipulate.

The cash processing machine 110 is a device that processes cash payments. The cash processing machine 110 handles deposited bills or coins. The cash processing machine 110 also discharges bills or coins serving as change (change back).

The speaker 111 is a device capable of outputting sound according to control of the self-service POS terminal 10.

The microphone 112 is a device to which sound can be input.

The hardware configuration of the self-service POS terminal 10 is not limited to the configuration explained above. The self-service POS terminal 10 components may be added, omitted, or varied as appropriate. In some examples, the display device 105, the input device 106, the card reader 107, the printer 108, the scanner 109, the cash processing machine 110, the speaker 111, and/or the microphone 112 may be separate from the self-service POS terminal 10.

Units (functions) realized by the processor 101.

The processor 101 realizes a detecting unit 1011, a communication unit 1012, and a display control unit 1013. The units realized by the processor 101 can also be referred to as functions. The units described as being realized by the processor 101 can also be considered as being realized by a control unit (controller) including the processor 101 and the main memory 102.

The detecting unit 1011 detects an event at the self-service POS terminal 10. The event at the self-service POS terminal 10 in this context is an event that needs to be handled by an attendant or to which the attendant needs to respond to in some manner.

The event at the self-service POS terminal 10 includes an event concerning an input (or inputs) made by the customer via the input device 106. In this example, the detecting unit 1011 detects an input by the customer made via the input device 106 at the self-service POS terminal 10. In the following explanation, an event related to the input(s) made by the customer via the input device 106 is referred to as a “first event” or “first-type event”.

The first event may include a request call. The request call is sent to the attendant who uses the attendant terminal 30. The request call may be referred to as “a request for a store clerk” or “a request for attendance”. The request call can include a communication of voice data between the self-service POS terminal 10 and the attendant terminal 30 via the network 40. The request call may involve display of a captured image in addition to or instead of voice communication. The attendant may handle a request call by intercom communication, physical attendance, or the like.

The first event may be a request for commodity return (an item registration cancellation). Handling of the request for commodity return by the attendant can be the input of registration cancellation permission via the attendant terminal 30 or otherwise.

The first event may be a request for commodity return after settlement. Handling of the request for commodity return after settlement by the attendant may be an input related to refund processing via the attendant terminal 30 or otherwise. The call request is executed at the self-service POS terminal 10 by the customer touching an icon (button) indicating “store clerk call” or the like displayed on a screen or pressing a physically provided “store clerk call” button.

The event at the self-service POS terminal 10 may be an event autonomously triggered (or otherwise initiated) by the self-service POS terminal 10. In such a case, the detecting unit 1011 may detect the event at the self-service POS terminal 10 based on some occurrence at the self-service POS terminal 10. In the following explanation, an event autonomously triggered by the self-service POS terminal 10 is referred to as a “second event” or a “second-type event”. A second type event does not depend on a specific input of a call request or the like at the self-service POS terminal 10 via the input device 106 by the customer. The second event can be autonomously triggered by the self-service POS terminal 10 without regard to the use (correct or not) of the self-service POS terminal 10 by the customer. Several examples of second events are explained below. However, the second events are not limited to these examples.

The second event may be a weight error. A weight error in this context indicates some error occurs although the operator (customer) performs a correct operation at the self-service POS terminal 10. For example, the weight error may be an error that occurs if a total weight of commodities is outside an acceptable weight range. For example, if it is assumed that five fruits of the same type are being registered when the total weight of the registered fruits is outside a weight range set for the fruit a weight error occurs. Handling of a weight error by the attendant can be an input of a release of an error via the attendant terminal 30 or otherwise.

The second event may be registration of a commodity with an age limit (an age limit commodity). An age limit commodity is, for example, a commodity prohibited to be sold to people under 20 years old, a so-called 20+ only commodity. For example, the 20+ only commodity may be alcohol or cigarettes. Handling of the registration of an age limit commodity may require the attendant to verify customer age via the attendant terminal 30 or otherwise.

The second event may be registration of a restricted pharmaceutical commodity such as certain types of drugs/medicines. Handling of the registration of the restricted pharmaceutical commodity by the attendant may require verification the customer is a permitted person for the purchase of the restricted pharmaceutical commodity.

The communication unit 1012 communicates with the attendant terminal 30 via the communication interface 104. The communication unit 1012 transmits, based on detection of an event at the self-service POS terminal 10 by the detecting unit 1011, a signal concerning the event to the attendant terminal 30. In the following explanation, the signal concerning the event is referred to as an event signal. After the communication unit 1012 transmits a signal concerning a call request to the attendant terminal 30, the communication unit 1012 receives a response from the attendant terminal 30. In the following explanation, this response is referred to as a response signal. The response signal may include a signal concerning a call start. A signal concerning a call start indicates that a call has been started. The response signal may include a signal concerning the suspension (delay) of the call start. The signal concerning the suspension of the call start indicates that the start of the call is delayed.

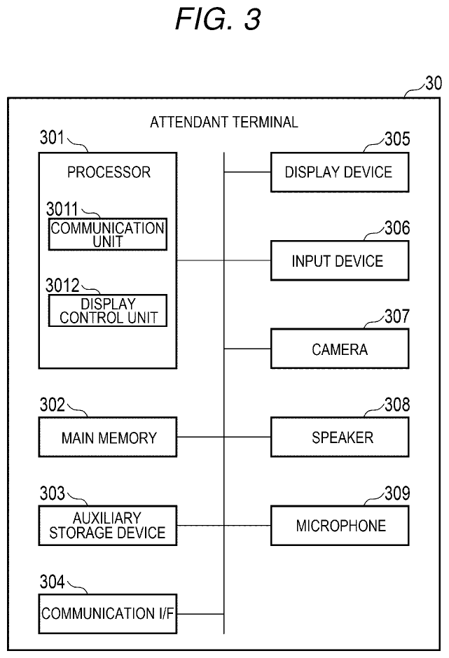

The communication unit 1012 transmits voice (sound) data based on voice (sound) input via the microphone 112 of the self-service POS terminal 10 to the attendant terminal 30. The voice input via the microphone 112 may include speech from the customer. The communication unit 1012 receives, from the attendant terminal 30, the voice data input via a microphone 309 of the attendant terminal 30 illustrated in FIG. 3. The voice input via the microphone 309 may include speech of the attendant. The communication unit 1012 receives, from the attendant terminal 30, captured image data acquired by a camera 307 of the attendant terminal 30 illustrated in FIG. 3. The captured image data acquired by the camera 307 is data including the face or the like of the attendant.

Here, an example is explained in which the communication unit 1012 transmits a signal, information, or data to the attendant terminal 30 and receives a signal, information, or data directly from the attendant terminal 30. However, the communication unit 1012 is not limited to this. The communication unit 1012 may exchange signals, information, or data with the attendant terminal 30 through a server or the like connected to the self-service POS terminal 10 and the attendant terminal 30. In such a case, the communication unit 1012 transmits a signal, information, or data addressed to the attendant terminal 30 to the server. The communication unit 1012 then receives a signal, information, or data addressed to the self-service POS terminal 10 from the attendant terminal 30 via the server.

The display control unit 1013 displays a first image on the display device 105. The first image can be an image related to any one of the various stages in a transaction. Here, an example is explained in which the first image relates to a commodity registration stage. However, the first image may be an image related to a checkout stage. The first image does not include a display region concerning a call. In the following explanation, the display region concerning a call is referred to as a “call display region”. The call display region is a region where an image relating to a call to the attendant or the like is displayed. A different image can be displayed in the call display region according to a present state or situation of the call. If the situation of the call is “calling”, an image indicating the “calling” state is displayed in the call display region. In an example, the image of “calling” is a captured image based on the captured image data acquired by the camera 307 of the attendant terminal 30. In this example, a real-time captured image including the face of the attendant is displayed in the call display region. In another example, the image of “calling” is an image of a non-specific character or an avatar. If the situation of the call is “call start suspended”, an image indicating the “call start suspended” state is displayed in the call display region. The image of the “call start suspended” is displayed when the customer (user) is kept waited (“on hold”) because the attendant is attending to another customer (user). For example, the image of the “call start suspended” is a message indicating that the call start has been suspended by the attendant. The image of the “call start suspended” may be an image of a message indicating turn waiting such as “Please wait for a while” or “[X] people are being currently attended” as the message indicating that the call start is suspended.

The display control unit 1013 displays a second image on the display device 105 based on the response signal. The second image relates to any one of the various stages in the transaction. Here, an example is explained in which the second image is an image related to a commodity registration stage. However, the second image in other examples may be an image related to a checkout stage. The second image is the image to which the first image transitions based on the response signal. The second image includes a call display region.

A configuration example of the attendant terminal 30 is explained.

FIG. 3 is a block diagram illustrating the attendant terminal 30.

The attendant terminal 30 includes a processor 301, a main memory 302, an auxiliary storage device 303, a communication interface 304, a display device 305, an input device 306, a camera 307, a speaker 308, and a microphone 309. The units configuring the attendant terminal 30 are connected to one another to be capable of inputting and outputting signals. In FIG. 3, interface is described as “I/F”.

The processor 301 can be a central processor of the attendant terminal 30. In general, the processor 301 can have the same hardware configuration(s) as the processor 101 already explained above. The processor 301 loads, in the main memory 302, programs from the main memory 302 or the auxiliary storage device 303 for realizing units (functions) explained below of the attendant terminal 30.

The main memory 302 is a main storage part of the attendant terminal 30. The main memory 302 can have the same hardware configuration as main memory 102 already explained above.

The auxiliary storage device 303 is an auxiliary storage part of the attendant terminal 30. The auxiliary storage device 303 can have the same hardware configuration as the auxiliary storage device 103 already explained above.

The communication interface 304 includes various interfaces for communicably connecting the attendant terminal 30 to other electronic equipment via the network 40 according to a predetermined communication protocol.

The display device 305 is for displaying various images according to control of the processor 301. The display device 305 can have the same hardware configuration as the display device 105 already explained above.

The input device 306 is for inputting of instructions based on operations of the attendant (user). The input device 306 can have the same hardware configuration as the input device 106 already explained above.

The camera 307 provides an imaging function and acquires captured image data. The camera 307 photographs (or acquires an image of) the face of the attendant who uses the attendant terminal 30.

The speaker 308 is a device capable of outputting sound according to control of the attendant terminal 30.

The microphone 309 is a device to which sound can be input.

The hardware configuration of the attendant terminal 30 is not limited to the present example, components may be added, omitted, and/or varied as appropriate. The display device 305, the input device 306, the camera 307, the speaker 308, and/or the microphone 309 may be separate from the attendant terminal 30.

The units (functions) realized by the processor 301 are explained.

The processor 301 realizes a communication unit 3011 and a display control unit 3012. The units realized by the processor 301 can also be considered as being realized by a control unit (controller) including the processor 301 and the main memory 302.

The communication unit 3011 communicates with each of the plurality of self-service POS terminals 10 via the communication interface 304. The communication unit 3011 receives an event signal from a self-service POS terminal 10. The communication unit 3011 transmits a response signal to the self-service POS terminal 10 based on an input of a response instruction via the input device 306 by the attendant. The response instruction is an instruction for a response to a request for a call. In an example, the communication unit 3011 transmits a signal concerning a call start to the self-service POS terminal 10 based on an input of a call start instruction via the input device 306 by the attendant. The call start instruction is an instruction to start a call. In another example, the communication unit 3011 transmits a signal concerning the suspension of the call start to the self-service POS terminal 10 based on an input of a call start suspension instruction via the input device 306 by the attendant. The call start suspension instruction is an instruction to suspend the call start. The communication unit 3011 receives, from the self-service POS terminal 10, voice data based on voice input via the microphone 112 of the self-service POS terminal 10. The communication unit 3011 receives, via the communication interface 304, captured image data acquired by the cameras 20. The communication unit 3011 transmits the captured image data acquired by the camera 307 to the self-service POS terminal 10. The communication unit 3011 transmits the voice data based on the voice input via the microphone 309 to the self-service POS terminal 10. Here, an example is explained in which the communication unit 3011 transmits a signal, information, or data to the self-service POS terminal 10 and receives a signal, information, or data from the self-service POS terminal 10. However, the communication unit 3011 is not limited to this. The communication unit 3011 may exchange signals, information, or data with the self-service POS terminal 10 via a server connected between the self-service POS terminal 10 and the attendant to 30.

The display control unit 3012 displays, based on a received event signal, an object indicating the self-service POS terminal 10 sending the event signal on the display device 305. In the following explanation, the object indicating the self-service POS terminal 10 is also referred to as POS terminal object. The display control unit 3012 displays two or more POS terminal objects indicating the two or more self-service POS terminals 10 on the display device 305 when an event signal is received from two or more of the self-service POS terminals 10. If displaying two or more POS terminal objects on the display device 305, the two or more POS terminal objects may be displayed on the display device 305 in a format permitting the attendant to identify a priority order for the two or more self-service POS terminals 10.

The priority order is a preferred order of handling of events by the attendant. The priority order may be a descending ranking set according to the particular events at the self-service POS terminals 10. For example, the ranks are importance degrees. The importance degrees can be set as appropriate based on various circumstances such as importance or emergency of requiring handling by the attendant and the expected handling efficiency by the attendant. As the importance degrees decrease, even if the handling by the attendant is suspended, influence on the customer in operating the self-service POS terminal 10 decreases. The importance degrees are explained using three stages of “high”, “medium”, and “low” as an example. The number of stages of the importance degrees is not limited to this. For example, the request for a call can be set to the importance degree “high”. The request for a call is an active request by the customer and the attendant generally cannot grasp matters related to the inquiry content until the starting of a call. Therefore, the importance degree of the request for a call is the highest. The weight error is set to the importance degree “medium”. The age limit commodity is set to the importance degree “low”. The registration of the restricted pharmaceuticals is set to the importance degree “low”. The request for commodity return involved in a registration cancellation is set to the importance degree “low”. The request for commodity return after a settlement is set to the importance degree “low”. The auxiliary storage device 303 may store data indicating relationship between the events of the self-service POS terminal 10 and the importance degrees. The data indicating the relationship between the events of the self-service POS terminal 10 and the importance degrees can be updated or modified as appropriate. Priority order of a plurality of POS terminal objects having the same importance degree may include ascending order of reception times of event signals by the communication unit 3011.

The format capable of identifying the priority order of the self-service POS terminals 10 includes the arrangement of the two or more POS terminal objects. In this example, the display control unit 3012 displays the two or more POS terminal objects on the display device 305 in an arrangement based on the events received from the two or more self-service POS terminals 10. The format for identifying the priority order may include changes in colors or sizes of the two or more POS terminal objects.

The POS terminal object includes or provides various kinds of information. The POS terminal object may include identification information such as a name indicating the particular self-service POS terminal 10 that transmits the event signal to the attendant terminal 30. The POS terminal object may include a reception time of the event signal. The POS terminal object may include an importance degree of the event specified by the event signal. The POS terminal object may include description of the event specified by the event signal. The POS terminal object may include an input key for inputting a response instruction. The POS terminal object may include an input key for inputting a call start instruction as the response instruction. The POS terminal object may include an input key for inputting a call start suspension instruction as the response instruction. According to the event specified by the event signal, the POS terminal object may include or may not include the input key for inputting the response instruction. This is because necessity of the attendant calling the customer changes according to an event of the self-service POS terminal 10. If the event of the self-service POS terminal 10 is the request for a call, the attendant needs to call the customer. In this example, the POS terminal object includes the input key for inputting the response instruction. If the event of the self-service POS terminal 10 is the weight error, the necessity of the attendant calling the customer is low. In this example, the POS terminal object need not include the input key for inputting the response instruction. The attendant terminal 30 sometimes receives a plurality of event signals from one self-service POS terminal 10 at the same time or in series. In this example, the POS terminal object may include information for each of the received event signals. The display control unit 3012 may set the priority order of the POS terminal object based on each of the events.

The display control unit 3012 displays a captured image concerning a target self-service POS terminal. For example, the captured image concerning the target self-service POS terminal is a captured image acquired by the camera 20 for the target self-service POS terminal. The display control unit 3012 displays the captured image on a display device that can be the same as the display device 305 that displays the POS terminal object. The display control unit 3012 can display the captured image on the display device 305 together with the POS terminal object. The display control unit 3012 can display the captured image on a display device that is different from the display device 305 but is still usable by the attendant. Here, an example is explained in which the display control unit 3012 displays the captured image on the display device 305.

The target self-service POS terminal is the self-service POS terminal 10 that is a target of handling by the attendant. The target self-service POS terminal is the self-service POS terminal 10 selected out of the two or more POS terminal objects which are displayed. The target self-service POS terminal is selected based on an input of a selection instruction for the target self-service POS terminal via the input device 306 by the attendant. The selection instruction for the target self-service POS terminal may include a call start instruction. The camera 20 related to the target self-service POS terminal is one or more cameras 20 that image a range covering the target self-service POS terminal. The camera 20 related to the target self-service POS terminal can be the camera 20 that images a customer who uses the target self-service POS terminal. The camera 20 related to the target self-service POS terminal can be the camera 20 that images a commodity storage place for s commodity return involved in registration cancellation at the target self-service POS terminal. The camera 20 related to the target self-service POS terminal can be the camera 20 that images a commodity storage place for a commodity return after settlement at the target self-service POS terminal.

The display control unit 3012 erases the display of the POS terminal object based on an input of an erasing instruction via the input device 306 by the attendant. The erasing instruction is an instruction to erase the display of the POS terminal object. The erasing includes transitioning from a display state to a non-display state. The erasing instruction may include a call end instruction input via the input device 306 by the attendant after a call start instruction. The call end instruction is an instruction to end a previously started call. The erasing instruction may be an instruction to erase the captured image in addition to the erasing of the POS terminal object. In this example, the display control unit 3012 erases the display of the captured image based on the input of the erasing instruction via the input device 306. The attendant can input, via the input device 306, an erasing instruction for a POS terminal object indicating the handled self-service POS terminal 10.

(Display Example)

A display example of an image at the self-service POS terminal 10 is explained. The first image includes a plurality of display regions. Each of the display regions is a region where common content is displayed. The display region may be a region where a frame is explicitly displayed or may be a virtual region where a frame is not explicitly displayed.

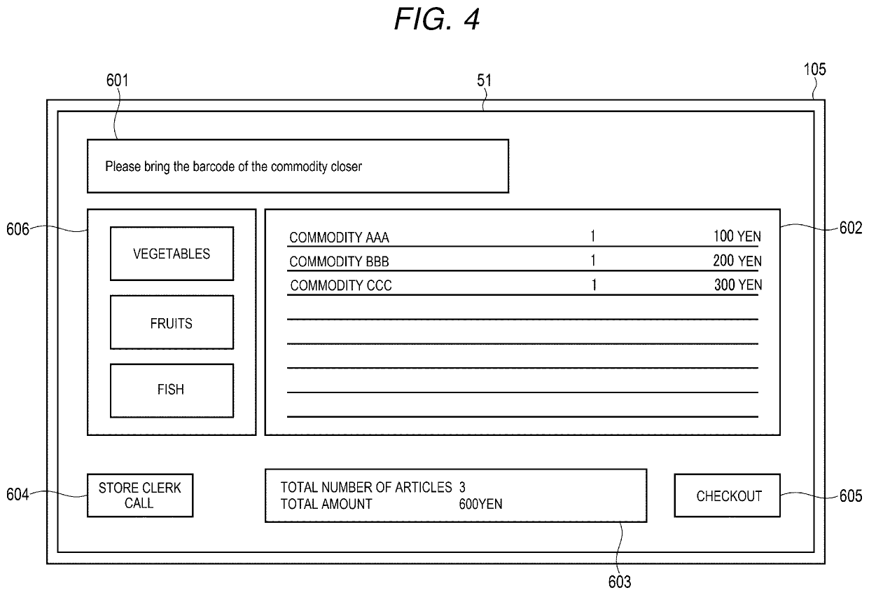

FIG. 4 is a diagram illustrating a display example of a first image 51 for the self-service POS terminal 10.

The display device 105 displays the first image 51.

The first image 51 includes display regions 601 to 606.

The display region 601 is where a message to the customer is displayed. The display region 602 is where details of registered commodities are displayed. The details may include a commodity name, the number of articles, and a price. The display region 603 is where a total number of articles and a total price of the registered commodities are displayed. The display region 604 is where an input key for inputting an instruction to request a call is displayed. The display region 605 is where an input key for inputting an instruction to transition an image displayed on the display device 105 from an image in the registration stage to an image in the checkout stage is displayed. The display region 606 is where one or more input keys for manually registering a commodity lacking a barcode or the like is displayed.

In an example, the second image includes a plurality of display regions that are different from the call display region. The plurality of display regions included in the second image can be some or all of the plurality of display regions shown in the first image. A position and a shape of each of the display regions included in the second image can be the same as a position and a shape of the corresponding display region included in the first image. The second image is an image obtained by superimposing the call display region on at least one display region among the plurality of display regions of the first image. The call display region may overlap part or all of one or more display region.

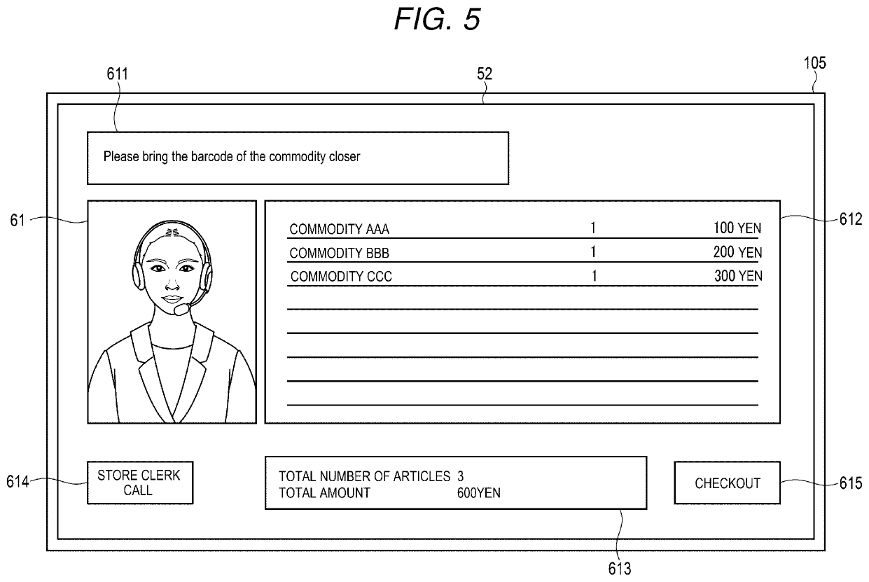

FIG. 5 is a diagram illustrating an example of display of a second image 52 at the self-service POS terminal 10.

The display device 105 displays the second image 52.

The second image 52 includes display regions 611 to 615 and a call display region 61.

The display regions 611 to 615 are regions corresponding to display regions 601 to 605. The display regions 611 to 615 are regions where the same contents as displayed in the display regions 601 to 605 are displayed. A position and a shape of each of display regions 611 to 615 is the same as a position and a shape of each of the display regions 601 to 605.

The second image 52 is an image obtained by superimposing the call display region 61 on the display region 606 in the first image 51. The call display region 61 overlaps the entire display region 606 of the first image 51. In the second image 52, the call display region 61 is visually recognizable as distinct from the display region 606. The call display region 61 may be set to overlap a part of the display region 606 in the first image 51. In this example, the second image 52 has a part of the display region 606 not overlapped by the call display region 61.

The positioning of the call display region 61 and/or the display region on which the call display region is superimposed is not particularly limited. The call display region 61 is preferably superimposed over a display region with information of low relevance during a call to the attendant. The display region 606 where the one or more input keys are displayed is an example of a display region where information with low relevance for a call to the attendant is displayed. In the display region 612 where the registered commodity details are displayed, provides information likely to be referred to by the customer during the call to the attendant. The display region 612 is an example of a display region where information with high relevance is displayed.

In another example, the second image includes a plurality of display regions that are different from the call display region. The plurality of display regions included in the second image are a part or all of the plurality of display regions. A format and/or positioning of each of the display regions included in the second image is different from the format of the corresponding display regions included in the first image. For example, the call display region is set to not overlap any display regions included in the second image. In some examples, the call display region may be superimposed on portions of the display regions included in the second image. The change of the format and/or position of a display region includes reducing the size one of the display region. One or more display region may be repositioned or rearranged.

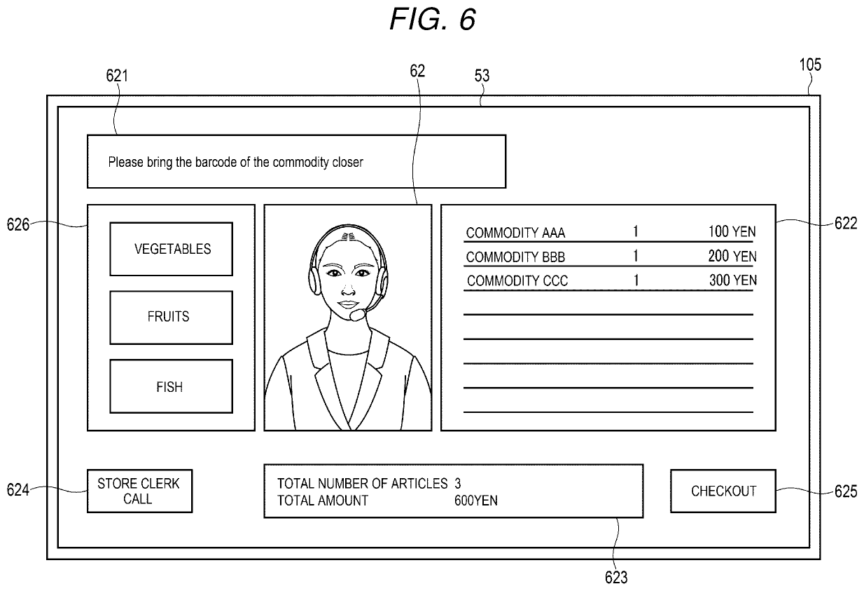

FIG. 6 is a diagram illustrating another example of display of a second image 53 at the self-service POS terminal 10.

The display device 105 displays the second image 53.

The second image 53 includes a plurality of display regions 621 to 626 and a call display region 62.

The plurality of display regions 621 to 626 are regions corresponding to the plurality of display regions 601 to 606. The plurality of display regions 621 to 626 are regions where the same contents as the contents of the plurality of display regions 601 to 606 are displayed. A position and a shape of each of a plurality of display regions 621 and 623 to 626 can be the same as a position and a shape of each of a plurality of display regions 601 and 603 to 605. A shape of the display region 622 is a shape obtained by reducing of the size of the display region 602 in the lateral direction. The second image 53 is an image obtained by changing the form of the display region 602 among the plurality of display regions 601 to 606. The call display region 62 can be generated by the reduction of the display region 602 to the display region 622. In the second image 53, the call display region 62 can be visually recognized together with the plurality of display regions 621 to 626.

The first image 51, the second image 52, and the second image 53 illustrated in FIGS. 4 to 6 are examples of the image in the registration stage of the commodity. However, the display device 105 can display the first image and the second image in the same manner in the checkout stage as well. For example, the display device 105 displays the first image in the checkout stage based on selection of a checkout button in the image in the registration stage of the commodity. The first image in the checkout stage includes display of a total amount and a payment amount and display of an input key (an icon) of “store clerk call” for inputting an instruction to request a call. The display device 105 displays the second image in the checkout stage based on selection of the input key of “store clerk call” in the first image in the checkout stage. The second image in the checkout stage includes display of the total amount and the payment amount and the call display region. The second image in the checkout stage is an image displayed at the time of a request for commodity return after settlement.

A display example of an image in the attendant terminal 30 is explained.

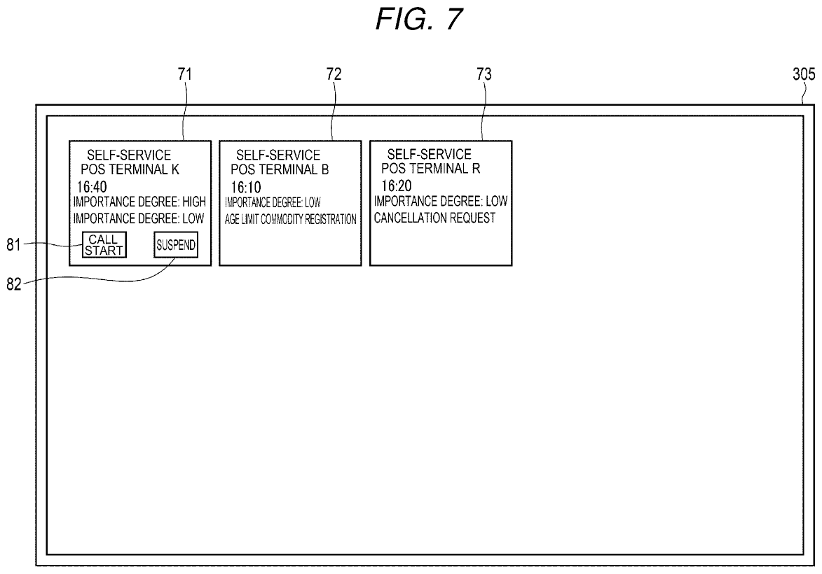

FIG. 7 is a diagram illustrating the display example in the attendant terminal 30.

The display control unit 3012 displays three POS terminal objects 71 to 73 on the display device 305. The POS terminal object 71 includes identification information “self-service POS terminal K”. The POS terminal object 71 includes reception time “16:40”. The POS terminal object 71 includes an importance degree “high”. The POS terminal object 71 includes an event “store clerk call”. The event “store clerk call” corresponds to the request for a call. The POS terminal object 71 includes a plurality of input keys for inputting a response instruction. The POS terminal object 71 includes an input key 81 for inputting a call start instruction as a response instruction. The POS terminal object 71 includes an input key 82 for inputting a call start suspension instruction as the response instruction. The POS terminal objects 72 and 73 include various kinds of information like the POS terminal object 71.

The importance degree illustrated in the POS terminal object 71 is higher than importance degrees illustrated in the POS terminal object 72 and the POS terminal object 73. The importance degree illustrated in the POS terminal object 72 and the importance degree illustrated in the POS terminal object 73 are the same. Reception time illustrated in the POS terminal object 72 is earlier than reception time illustrated in the POS terminal object 73. The priority order is the order of a “self-service POS terminal K” illustrated in the POS terminal object 71, a “self-service POS terminal B” illustrated in the POS terminal object 72, and a “self-service POS terminal R” illustrated in the POS terminal object 73. The display control unit 3012 displays the POS terminal object 71, the POS terminal object 72, and the POS terminal object 73 on the display device 305 from the left side in the lateral direction in this arrangement.

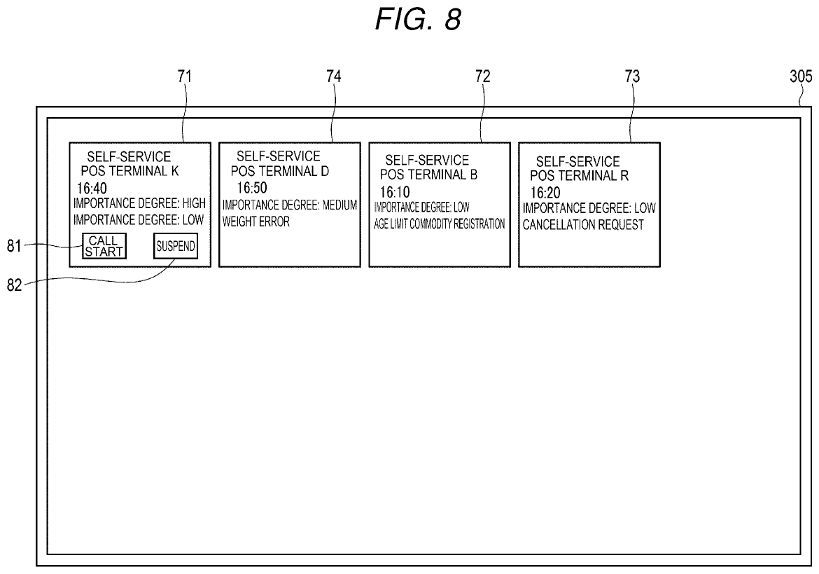

FIG. 8 is a diagram illustrating another display example in the attendant terminal 30.

FIG. 8 illustrates an example in which a POS terminal object 74 is displayed on the display device 305 in addition to the three POS terminal objects 71 to 73 illustrated in FIG. 7.

It is assumed that the communication unit 3011 receives an event signal from the self-service POS terminal 10 identified by a “self-service POS terminal D”. It is assumed that the display of the three POS terminal objects 71 to 73 is not erased.

The display control unit 3012 updates priority order of the four self-service POS terminals 10 based on acquisition of the event signal from the “self-service POS terminal D” by the communication unit 3011. An importance degree illustrated in the POS terminal object 74 is lower than the importance degree illustrated in the POS terminal object 71. The importance degree illustrated in the POS terminal object 74 is higher than the importance degrees illustrated in the POS terminal object 72 and the POS terminal object 73. The priority order is the order of the “self-service POS terminal K” illustrated in the POS terminal object 71, the “self-service POS terminal D” illustrated in the POS terminal object 74, the “self-service POS terminal B” illustrated in the POS terminal object 72, and the “self-service POS terminal R” illustrated in the POS terminal object 73. The display control unit 3012 displays the POS terminal object 71, the POS terminal object 74, the POS terminal object 72, and the POS terminal object 73 on the display device 305 from the left side in the lateral direction in this arrangement.

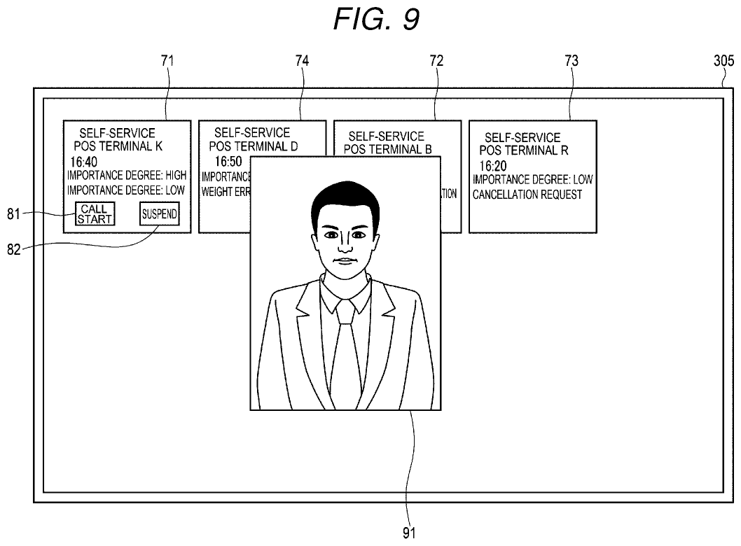

FIG. 9 is a diagram illustrating still another display example in the attendant terminal 30.

It is assumed that the attendant selects the input key 81 illustrated in the POS terminal object 71 to thereby input a call start instruction via the input device 306. The target self-service POS terminal is a “self-service POS terminal K”.

The communication unit 3011 receives captured image data acquired by the camera 20 related to the “self-service POS terminal K”. For example, the captured image data is data including the face or the like of a user who uses the “self-service POS terminal K”. The display control unit 3012 displays, on the display device 305, a captured image 91 based on the captured image data acquired by the camera 20 related to the “self-service POS terminal K”. The captured image 91 is a real-time image during a call including the face or the like of the customer who uses the “self-service POS terminal K”.

(Operation Example)

Subsequently, an operation example of the checkout system 100 configured as explained above is explained.

A processing procedure explained below is only an example. Respective kinds of processing may be changed as much as possible. About the processing procedure explained below, omission, replacement, and addition of steps are possible as appropriate according to the embodiment.

The operation of the self-service POS terminal 10 is explained.

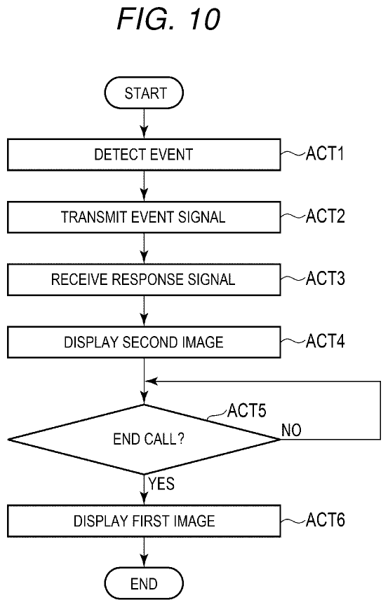

FIG. 10 is a flowchart illustrating processing of the self-service POS terminal 10. It is assumed that the display device 105 displays the first image.

The detecting unit 1011 detects an event of the self-service POS terminal 10 (ACT 1).

The communication unit 1012 transmits an event signal to the attendant terminal 30 based on the detection of the event of the self-service POS terminal 10 by the detecting unit 1011 (ACT 2).

The communication unit 1012 receives a response signal from the attendant terminal 30 (ACT 3).

The display control unit 1013 displays a second image on the display device 105 based on the response signal (ACT 4). In ACT 4, for example, the display control unit 1013 transitions, based on the reception of the response signal by the communication unit 1012, an image displayed on the display device 105 from the first image to the second image.

If the response signal is a signal concerning suspension of a call start, the display control unit 1013 displays an image “call start suspended” in the call display region. If the response signal is a signal concerning the call start, the display control unit 1013 displays an image of “calling” in the call display region. The communication unit 1012 transmits voice data based on voice input via the microphone 112 of the self-service POS terminal 10 to the attendant terminal 30 during a call. The communication unit 1012 receives the voice data based on the voice input via the microphone 309 of the attendant terminal 30 from the attendant terminal 30 during the call. The speaker 111 outputs voice based on voice data received by the communication unit 1012. The communication unit 1012 sometimes receives captured image data acquired by the camera 307 of the attendant terminal 30 from the attendant terminal 30 during the call. The display control unit 1013 displays a captured image based on the captured image data received by the communication unit 1012 in the call display region.

The communication unit 1012 sometimes receives the signal concerning the call start after receiving the signal concerning the suspension of the call start. In this example, the display control unit 1013 transitions, based on the reception of the signal concerning the call start by the communication unit 1012, an image displayed in the call display region from the image of “call start suspended” to the image of “calling”.

The display control unit 1013 determines whether to end the call (ACT 5). In ACT 5, for example, the display control unit 1013 may determine to end the call based on an input of a call end instruction via the input device 106 by the customer. The display control unit 1013 may determine to end the call based on reception of a signal concerning a call end from the attendant terminal 30 by the communication unit 1012. The signal concerning the call end is a signal based on a call end instruction input via the input device 306 by the attendant. If not to determine to end the call (NO in ACT 5), the display control unit 1013 repeats the processing in ACT 5. If the display control unit 1013 determines to end the call (YES in ACT 5), the processing transitions from ACT 5 to ACT 6.

If ending the call, the display control unit 1013 displays the first image on the display device 105 (ACT 6). In ACT 6, for example, the display control unit 1013 transitions an image displayed on the display device 105 from the second image to the first image.

The event specified by the event signal transmitted to the attendant terminal 30 by the communication unit 1012 in ACT 2 sometimes does not require a call. In this example, the processing in ACT 3 to ACT 6 can be omitted. The detecting unit 1011 sometimes detects a plurality of events at the same or different timings. In this example, the processing in ACT 1 and ACT 2 is repeated a plurality of times.

The operation of the attendant terminal 30 is explained.

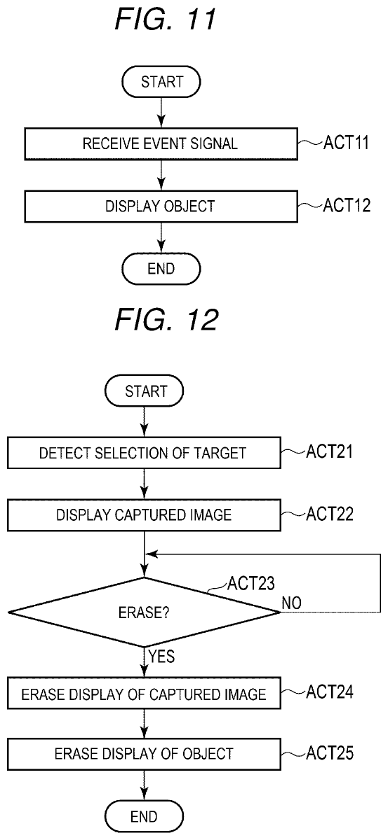

FIG. 11 is a flowchart illustrating an example of display processing in the attendant terminal 30.

The attendant terminal 30 executes processing illustrated below every time the attendant terminal 30 receives an event signal.

The communication unit 3011 receives an event signal from the self-service POS terminal 10 (ACT 11).

The display control unit 3012 displays a POS terminal object on the display device 305 based on the event signal (ACT 12). A case in which the display device 305 does not display a POS terminal object is explained. In this example, a display target POS terminal object is only a new POS terminal object based on the event signal received by the communication unit 3011. The display control unit 3012 displays, based on the reception of the event signal by the communication unit 3011, a new POS terminal object based on the event signal on the display device 305.

A case in which the display device 305 displays one or more POS terminal objects is explained. In this example, display target POS terminal objects are two or more POS terminal objects including one or more POS terminal objects being displayed on the display device 305 and the new POS terminal object based on the event signal received by the communication unit 3011. The display control unit 3012 updates, based on the reception of the event signal by the communication unit 3011, priority order of two or more self-service POS terminals 10 including the self-service POS terminal 10, which is a transmission source of the event signal. The display control unit 3012 displays, based on the update of the priority order, the two or more POS terminal objects including the new POS terminal object on the display device 305. The display control unit 3012 displays the two or more POS terminal objects on the display device 305 in a form capable of identifying the priority order of the two or more self-service POS terminals 10. For example, the display control unit 3012 changes arrangement of the two or more POS terminal objects according to the priority order. The display control unit 3012 displays the two or more POS terminal objects on the display device 305 in arrangement based on events of the two or more self-service POS terminals 10.

FIG. 12 is a flowchart illustrating another example of the display processing in the attendant terminal 30.

The display control unit 3012 detects selection of a target self-service POS terminal (ACT 21). In ACT 21, for example, the display control unit 3012 detects the selection of the target self-service POS terminal based on an input of a selection instruction for the target self-service POS terminal via the input device 306.

The display control unit 3012 displays, on the display device 305, a captured image based on captured image data acquired by the camera 20 related to the target self-service POS terminal (ACT 22). In ACT 22, for example, the communication unit 3011 receives the captured image data acquired by the camera 20 related to the target self-service POS terminal. The display control unit 3012 displays, on the display device 305, the captured image based on the captured image data received by the communication unit 3011.

The display control unit 3012 may display, on the display device 305, a captured image under imaging conditions corresponding to an event of the target self-service POS terminal. The imaging conditions are conditions concerning imaging by the camera 20 that acquires the captured image data. The imaging conditions may include an imaging range. The imaging range is a range imaged by the camera 20. The imaging range includes a target to be imaged. The imaging conditions may include an imaging time. The imaging time is timing when the imaging is performed by the camera 20. The timing when the imaging is performed is, for example, a real time or a time having any length including a point in time in the past. The imaging conditions may be a combination of the imaging range and the imaging time.

A case in which an event of the self-service POS terminal 10 is a request for a “store clerk call”, that is, a “call” is explained. The imaging range may be a range including the face or the like of a customer who uses the target self-service POS terminal. The imaging time may be a real time. Consequently, the attendant can appropriately call the customer while viewing the face of the customer in a real time.

A case in which the event of the self-service POS terminal 10 is the weight error is explained. The imaging range may be a range including the hand or the like of the customer who uses the target self-service POS terminal. The imaging time may be a time having any length including reception time of an event signal by the attendant terminal 30 corresponding to occurrence time of the event. Consequently, the attendant can appropriately determine necessity of release of an error by checking the hand of the customer in a time including an occurrence point in time of the weight error.

A case in which the event of the self-service POS terminal 10 is the registration of the age limit commodity is explained. The imaging range may be a range including the face or the like of the customer who uses the target self-service POS terminal. The imaging time may be a real time. Consequently, the attendant can appropriately determine necessity of permission of the registration of the age limit commodity by checking the face of the customer who registers the age limit commodity.

A case in which the event of the self-service POS terminal 10 is the request for commodity return involved in registration cancellation is explained. The imaging range may be a range including a commodity storage place for the commodity return involved in registration cancellation correlated with the target self-service POS terminal. The imaging time may be a real time. Consequently, the attendant can determine, by checking a situation of the commodity storage place in a real time, whether the commodity return involved in registration cancellation is appropriately performed.

A case in which the event of the self-service POS terminal 10 is the request for commodity return after settlement is explained. The imaging range may be a range including a commodity storage place for the commodity return after settlement correlated with the target self-service POS terminal. The imaging time may be a real time. Consequently, the attendant can determine, by checking a situation of the commodity storage place in a real time, whether the commodity return after settlement is appropriately performed by the customer.

If the imaging time is real time, the display control unit 3012 displays, on the display device 305, a captured image based on captured image data in the real time as received by the communication unit 3011. If the imaging time is a time in the past, the display control unit 3012 displays, on the display device 305, a captured image based on captured image data in the time in the past received by the communication unit 3011. In this example, the auxiliary storage device 303 may store the captured image data in the past received by the communication unit 3011.

The communication unit 3011 receives, from the self-service POS terminal 10, voice data based on voice input via the microphone 112 of the self-service POS terminal 10 during the call. The speaker 308 outputs voice based on the voice data received by the communication unit 3011. The communication unit 3011 transmits voice data based on voice input via the microphone 309 of the attendant terminal 30 to the self-service POS terminal 10 during the call. The communication unit 3011 periodically transmits, to the self-service POS terminal 10, captured image data acquired by the camera 307 of the attendant terminal 30 during the call.

The display control unit 3012 determines whether to erase a POS terminal object concerning the target self-service POS terminal (ACT 23). In ACT 23, for example, the display control unit 3012 may determine, based on an input of an erasing instruction via the input device 306, to erase the POS terminal object concerning the target self-service POS terminal. If not determining to erase the POS target object (NO in ACT 23), the display control unit 1013 repeats the processing in ACT 23. If the display control unit 1013 determines to erase the POS terminal object (YES in ACT 23), the processing transitions from ACT 23 to ACT 24.

The display control unit 3012 erases the display of the captured image based on the input of the erasing instruction via the input device 306 (ACT 24).

The display control unit 3012 erases, based on the input of the erasing instruction via the input device 306, the display of the POS terminal object concerning the target self-service POS terminal (ACT 25). The display control unit 3012 displays, on the display device 305, one or more POS terminal objects continued to be displayed in arrangement in which the display of the POS terminal object is erased.

Example embodiments include: A transaction support apparatus including: a communication unit configured to transmit a signal concerning a request for a call between a user of the transaction support apparatus and a user of electric equipment different from the transaction support apparatus and receive a response to the signal concerning the request for a call; and a display control unit configured to display a first image not including a display region concerning a call on a display and display, based on the response, a second image including the display region concerning the call on the display.

For a transaction support apparatus as described above, the first image may include a plurality of display regions, and the second image can be an image obtained by superimposing the display region concerning the call on at least one display region among the plurality of display regions.

For a transaction support apparatus as described above, the first image may include a plurality of display regions, and the second image can be an image obtained by changing a form of at least one display region among the plurality of display regions. In one example, a program causes a computer to execute a method including: transmitting a signal concerning a request for a call between a user of a transaction support apparatus and a user of electric equipment different from the transaction support apparatus; receiving a response to the signal concerning the request for a call; displaying a first image not including a display region concerning a call on a display; and displaying, based on the response, a second image including the display region concerning the call on the display.

(Effects)

The display processing apparatus according to an embodiment receives a signal concerning an event of a transaction support apparatus. The display processing apparatus displays, based on the signal concerning the event at the transaction support apparatus, an object (e.g., an icon or pictographic representation) indicating the transaction support apparatus on the display. If displaying a plurality of objects corresponding to different transaction support apparatuses on the display, the display processing apparatus displays the plurality of objects on the display in a form identifying a priority order for the transaction support apparatuses set based on events and/or event types at the respective transaction processing apparatuses.

In this way, the display processing apparatus displays the plurality of objects in the form capable of identifying a priority order of the plurality of transaction support apparatuses. Therefore, the display processing apparatus can clarify and display handling order for an attendant or the like. Since the priority order of the plurality of transaction support apparatuses is based on the events at the plurality of transaction support apparatuses, the display processing apparatus can display the plurality of objects in order of required or suggested handling. Since an attendant can see the order of required/suggested handling, the attendant can more efficiently handle events at a plurality of transaction support apparatuses. It is thus possible to monitor a larger number of transaction support apparatuses with a smaller number of attendants. The display processing apparatus of an example embodiment can support improvements in handling efficiency of the transaction support apparatus by the attendant.

### Other Embodiments

In an example the self-service POS terminal 10 displays the display region concerning the call on the display device 105. However, embodiments are not limited to this. The display control unit 1013 may display the display region concerning the call on a display device different from the display device 105 used for display of the first image. The display device different from the display device 105 can be any display device usable by the customer. The display device different from the display device 105 may be included in the self-service POS terminal 10 as second display device or may be separate from the self-service POS terminal 10. In such an example, the display control unit 1013 displays, based on the reception of the response signal by the communication unit 1012, the display region concerning the call on a display device different from the display device 105. The display control unit 1013 does not need to transition the image displayed on the display device 105 from the first image to the second image based on the reception of the response signal by the communication unit 1012.

The transaction support apparatus may be realized by one apparatus such as the self-service POS terminal 10 or may be realized by a plurality of apparatuses to which different functions are distributed. The display processing apparatus may be realized by one apparatus such as the attendant terminal 30 or may be realized by a plurality of apparatuses to which functions are distributed.

A program may be stored in electronic equipment upon initial transfer or may be transferred subsequently. In the latter case, the program may be transferred via a network or stored in a recording medium. The recording medium is a non-transitory tangible medium. The recording medium is a computer-readable medium. The recording medium only has to be a medium capable of storing the program and readable by a computer such as a CD-ROM or a memory card and a form of the recording medium does not matter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display processing apparatus, comprising:
a communication interface configured to connect to a plurality of transaction support apparatuses; and
a processor configured to:
receive an event signal related to an event at a transaction support apparatus via the communication interface; and
display an object corresponding to the transaction support apparatus on a display, wherein
if a plurality of objects corresponding to transaction support apparatuses are displayed on the display, the plurality of objects are displayed in a format indicating a priority ordering of the transaction support apparatuses set based on the events at the transaction support apparatuses.

2. The display processing apparatus according to claim 1, wherein the format indicating priority ordering is an arrangement order on the display.

3. The display processing apparatus according to claim 1, wherein a captured image related to a selected one of the transaction support apparatuses is displayed on the display.

4. The display processing apparatus according to claim 3, wherein the captured image is sent from the selected transaction support apparatus.

5. The display processing apparatus according to claim 3, wherein the captured image is sent from a camera positioned to image the selected transaction support apparatus.

6. The display processing apparatus according to claim 1, wherein the event is a user selection of a call button at the transaction support apparatus.

7. The display processing apparatus according to claim 1, wherein the event is a weight error occurring at the transaction support apparatus.

8. The display processing apparatus according to claim 1, wherein the event is an attempt to purchase an age-restricted item at the transaction support apparatus.

9. A transaction processing system, comprising:
a plurality of transaction processing apparatuses at which a customer register items for purchase and pay for registered items; and
an attendant terminal communicably connected to the plurality of transaction processing apparatuses by a network, the attendant terminal including:
a display screen to display information to an attendant,
a communication interface configured to connect to the network, and
a processor configured to:
receive an event signal related to an event at a transaction support apparatus via the communication interface, and
display an object corresponding to the transaction support apparatus on the display screen, wherein
if a plurality of objects corresponding to transaction support apparatuses are displayed on the display screen, the plurality of objects are displayed in a format indicating a priority ordering of the transaction support apparatuses set based on the events at the transaction support apparatuses.

10. The transaction processing system according to claim 9, wherein the format indicating the priority ordering is an arrangement order on the display screen.

11. The transaction processing system according to claim 9, wherein a captured image related to a selected one of the transaction support apparatuses is displayed on the display screen.

12. The transaction processing system according to claim 11, wherein the captured image is sent from the selected transaction support apparatus.

13. The transaction processing system according to claim 11, wherein the captured image is sent from a camera positioned to image the selected transaction support apparatus.

14. The transaction processing system according to claim 9, wherein the event is a user selection of a call button at the transaction support apparatus.

15. The transaction processing system according to claim 9, wherein the event is an attempt to purchase an age-restricted item at the transaction support apparatus.

16. A display control method for an attendant terminal in a transaction processing system, the method comprising:
receiving an event signal related to an event at a transaction support apparatus via a communication interface, and
displaying an object corresponding to the transaction support apparatus on a display screen, wherein
if a plurality of objects corresponding to transaction support apparatuses are displayed on the display screen, the plurality of objects are displayed in a format indicating a priority ordering of the transaction support apparatuses set based on the events at the transaction support apparatuses.

17. The display control method according to claim 16, wherein a captured image related to a selected one of the transaction support apparatuses is displayed on the display.

18. The display control method according to claim 17, wherein the captured image is sent from the selected transaction support apparatus.

19. The display control method according to claim 16, wherein the event is a user selection of a call button at the transaction support apparatus.

20. The display control method according to claim 16, wherein the event is an attempt to purchase an age-restricted item at the transaction support apparatus.
